(19) United States
(12) Patent Application Publication
(10) Pub. No.: US 2004/0258452 A1
(43) Pub. Date: Dec. 23, 2004

(54) Multi-section body-painting crayon

(76) Inventor: Der Jon Shyu, Luodung Jen (TW)

Correspondence Address: David E. Dougherty, Dennison, Schultz, Dougherty & MacDonald, Suite 105, 1727 King Street, Alexandria, VA, 22314, US

(21) Appl. No.: 10/463,428

(22) Filed: Jun. 18, 2003

(51) Int. Cl. B43K 27/02

(52) U.S. Cl. 401/57; 401/18

(57) ABSTRACT

A multi-section body-painting crayon includes a plurality of hollow cylinders, each of which forms one section of the crayon. The cylinder is provided at front and rear ends with exterior and interior connecting portions, respectively. The exterior connecting portion of each cylinder is adapted to detachably connect to the interior connecting portion of another cylinder, so that the cylinders may be continuously connected end to end to form a long barrel for the crayon suitable for holding with one hand. A cake of paint of a specific color is fixed to the front end of each cylinder. A user may easily change the number, position, and color of the cylinders to be included in the crayon and conveniently carry the crayon for use at any time and place.

### FIELD OF THE INVENTION

The present invention relates to a body-painting crayon, and more particularly to a multi-section body-painting crayon that includes a plurality of detachably connected hollow cylinders, each of which has a cake of paint of a specific color fixed to a front end thereof to enable easy and convenient access of different colors during body painting.

### BACKGROUND OF THE INVENTION

Body painting has changed from an avant-garde artistic work to a fashion trend. Young people even accept it as part of their makeup in daily life. The body painting may be done, for example, on a person's face or other selected body area.

Conventionally, paint for body painting is manufactured into the form of an individual cake. When a specific color is desired for body painting, a cake of paint with this specific color is picked up for use. A user's fingers tend to be smudged due to direct contact with different cakes of paint. Moreover, when a number of cakes of paint are used for body painting at the same time, it is inevitable the cakes are disorderly scattered over a desk. Another problem is it is not easy to carry paint cakes of all colors with the user, and shortage of any paint of specific color would cause troubles in touching up the painting when the same forms part of the user's makeup.

### SUMMARY OF THE INVENTION

It is therefore a primary object of the present invention to provide a multi-section body-painting crayon having a long barrel formed from a plurality of serially connected hollow cylinders, and a cake of print of a specific color fixed on each of the cylinders, so that a user may conveniently hold the crayon for body painting and easily access any desired color from the connected cylinders.

The multi-section body-painting crayon of the present invention includes a cap detachably cover a tip of the crayon, so that a user may conveniently carry the crayon in a bag for use at any time without interfering with other articles in the same bag.

To enable the hollow cylinders of the multi-section body-painting crayon of the present invention to easily detach from one another for the purpose of changing the desired paint to the tip of the crayon for use, each of the cylinders is provided at a front end with an exterior connecting portion, such as some external screw threads, and at a rear end with an interior connecting portion, such as some internal screw threads, so that any two cylinders may be quickly connected or detached simply by turning them relative to each other.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a multi-section body-painting crayon according to a preferred embodiment of the present invention;

FIG. 2 is an assembled perspective view of FIG. 1;

FIG. 3 shows a cap of the multi-section body-painting crayon of the present invention is removed and any desired one of the multiple sections of the crayon may be moved to the front of the crayon or separated from the crayon for use;

FIG. 4 is a partially exploded sectional view of the present invention; and

FIG. 5 is an assembled view of FIG. 4.

### DETAILED DESCRIPTION OF THE PREFERRED EMBODIMENTS

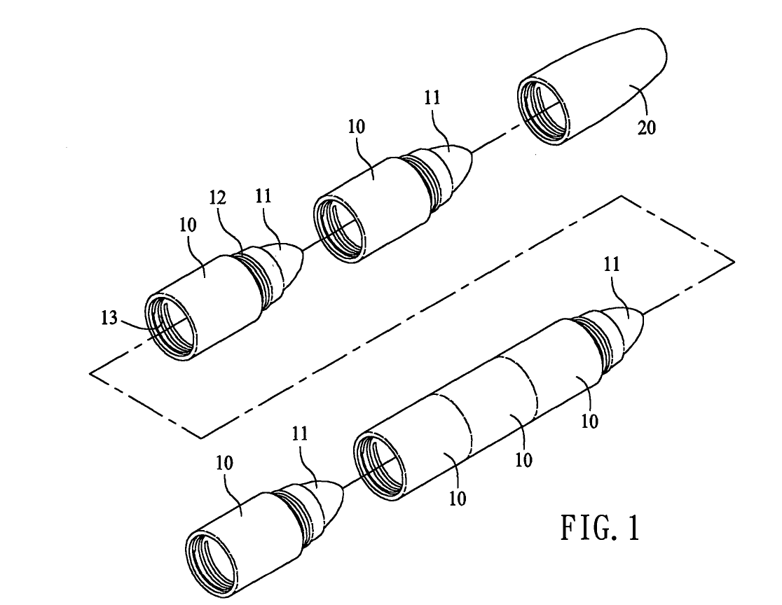

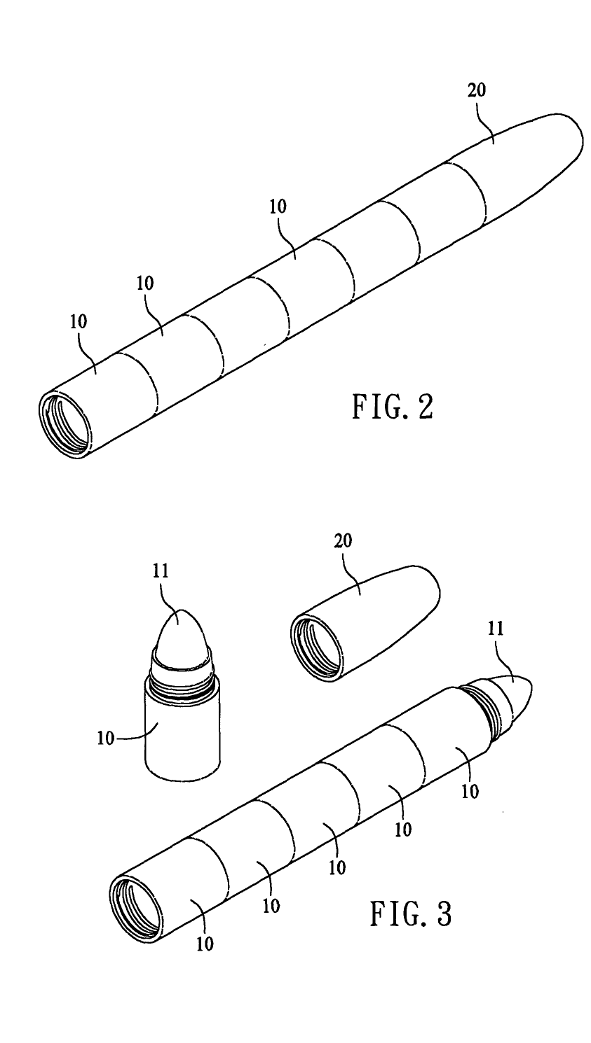

Please refer to FIGS. 1 and 2 that are exploded and assembled perspective views, respectively, of a multi-section body-painting crayon according to a preferred embodiment of the present invention. As shown, the present invention includes a plurality of cylinders 10 sequentially connected end to end to form a long barrel. Each of the cylinders 10 constitutes one section of the crayon and has a cake of paint 11 of a specific color for body painting fixed to a front end thereof.

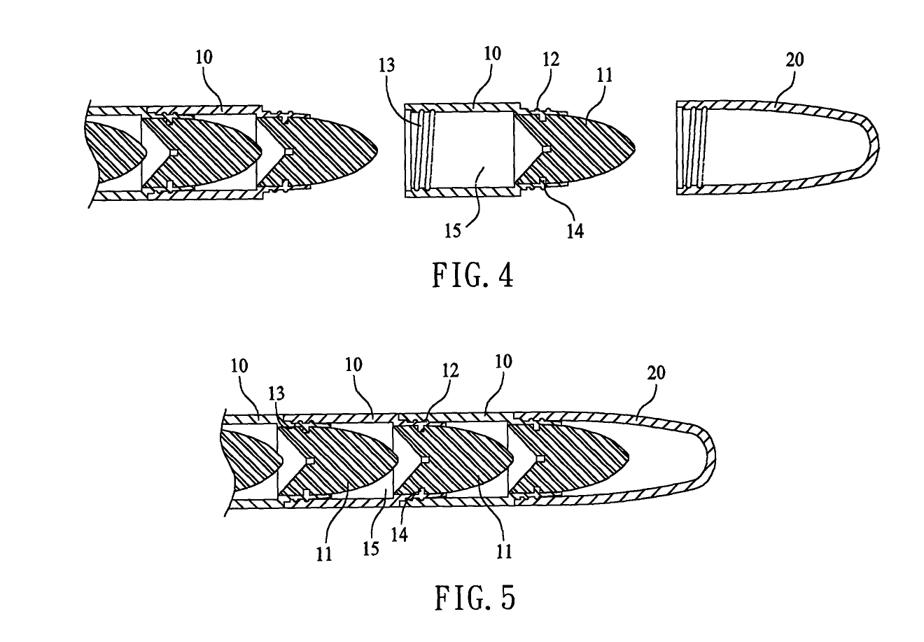

Please refer to FIGS. 4 and 5 that are partially exploded and fully assembled sectional views, respectively, of the body-painting crayon of the present invention. Each cylinder 10 is provided at a front end with an exterior connecting portion 12, which may include, for example, external screw threads as illustrated in the drawings, and at a rear end with an interior connecting portion 13, which may include, for example, internal screw threads adapted to engage with the external screw threads of the exterior connecting portion 12 of another cylinder 10 of the body-painting crayon. Therefore, the cylinders 10 may be serially connected end to end to form a barrel having a certain length suitable for holding with one hand to proceed with body painting. Each of the cylinders 10 is also provided on an inner wall surface of the front end with a retaining ring 14 for holding the cake of paint 11 in place in the front end of the cylinder 10 without the risk of being easily displaced. Each of the cylinders 10 defines an inner hollow space 15 therein. The space 15 is large enough to receive one full cake of paint 11 fixed to and projected from the front end of a next cylinder 10 screwed into the interior connecting portion 13 of a preceding cylinder 10. That is, an overall length of a complete cake of paint 11 exposed from the front end of the cylinder 10 is smaller than an overall length of the space 15, so that the cake of paint 11 on the next cylinder 10 may be received in the space 15 of the preceding cylinder 10 without interfering with the cake of paint 11 on the preceding cylinder 10.

The cake of paint 11 fixed to the front end of each cylinder 10 has a specific color. Since the cylinders 10 may be easily connected to and separated from one another at the exterior and the interior connecting portions 12, 13 that are detachably connected together, a user may conveniently change the number, position, and color of the cylinders 10 to be included in the multi-section body-painting crayon.

A cap 20 is removably closed onto the exterior connecting portion 12 at the front end of the first cylinder 10 in the multi-section body-painting crayon to cover the cake of paint 11 exposed from the first cylinder 10. This design enables a user to conveniently carry the multi-section body-painting crayon for use at any place at any time, and to position the crayon in a bag without staining other articles in the same bag.

Please refer to FIG. 3. To use the multi-section body-painting crayon, simply remove the cap 20 and separate the exterior connecting portions 12 from the interior connecting portion 13 at a selected position to move one cylinder 10 having the desired color to the tip of the crayon. With the cake of paint 11 having the desired color exposed from the tip of the crayon, the body painting may be started.

Of course, if preferred, it is also possible for the user to separate one single cylinder 10 having the desired color from the multi-sectioned barrel of the crayon, and hold the separated cylinder 10 with fingers during body painting.

It is to be understood the cylinders 10 are not necessarily connected to one another by means of screw threads provided on the exterior and the interior connecting portions 12, 13. Other connecting manners, such as recess and retaining block, hook and catch, etc., may also be employed in implementing the present invention. The present invention has been described with a preferred embodiment thereof and it is understood that many changes and modifications in the described embodiment can be carried out without departing from the scope and the spirit of the invention as defined by the apcrayonded claims.

What is claimed is:

1. A multi-section body-painting crayon, comprising a plurality of hollow cylinders, each of which forming one section of said body-painting crayon; each of said hollow cylinders being provided at a front end with an exterior connecting portion, and at a rear end with an interior connecting portion, said interior connecting portion of any said cylinder being adapted to engage with said exterior connecting portion of another said cylinder, and said exterior connecting portion of any said cylinder being adapted to engage with said interior connecting portion of another said cylinder, enabling said cylinders to serially connect end to end to form a long barrel suitable for holding with one hand to proceed with body painting; and each of said cylinders having a cake of paint fixed to and exposed from said front end, and an overall length of said cake of paint being smaller than an overall length of a space defined in each said hollow cylinder.

2. The multi-section body-painting crayon as claimed in claim 1, further comprising a cap adapted to close onto said front end of said cylinders for removably cover said cake of paint exposed from a most front one of said cylinders included in said body-painting crayon.

3. The multi-section body-painting crayon as claimed in claim 1, wherein each of said cylinders is provided on an inner wall surface of said front end with a retaining ring for holding said cake of paint in place in said front end of said cylinder.

4. The multi-section body-painting crayon as claimed in claim 1, wherein said exterior connecting portion comprises external screw threads, and said interior connecting portion comprises internal screw threads.
